(19) United States
(12) Patent Application Publication
(10) Pub. No.: US 2014/0141122 A1
(43) Pub. Date: May 22, 2014

(54) CONVERSION OF SOYBEAN HULLS TO ETHANOL AND HIGH-PROTEIN FOOD ADDITIVES

(71) Applicant: The Trustees of Dartmouth College, Hanover, NH (US)

(72) Inventors: Jonathan Richard Mielenz, Rockwood, TN (US); John S. Bardsley, Newport, NH (US)

(73) Assignee: The Trustees of Dartmouth College, Hanover, NH (US)

(21) Appl. No.: 14/077,965

(22) Filed: Nov. 12, 2013

Related U.S. Application Data
(63) Continuation of application No. 12/440,629, filed on Aug. 26, 2009.
(60) Provisional application No. 60/843,650, filed on Sep. 11, 2006.

(51) Int. Cl. A23L 1/20

(52) U.S. Cl. CPC A23L 1/2008
USPC 426/46; 426/634

(57) ABSTRACT

Soybean hull fermentation methods that produce food additives having a high protein content are disclosed. The protein is generally present as unhydrolyzed and non-racemized protein that possesses a complete amino acid profile. The food additive is suitable for consumption by a wide variety of animals, including humans.

### RELATED APPLICATIONS

This application is a continuation of U.S. Patent Application Ser. No. 12/440,629, filed Mar. 10, 2009, which is a U.S. National Phase entry of PCT Patent Application PCT/US07/78166, filed Sep. 11, 2007, which claims the benefit of priority to commonly-owned and copending U.S. Provisional Patent Application No. 60/843,650, filed 11 Sep. 2006, the disclosures of which are incorporated herein by reference.

### GOVERNMENT INTERESTS

The United States Government may have certain rights in the present invention as research relevant to its development was funded by National Institute of Standards and Technology (NIST) contract number 60NANB1 D0064.

### BACKGROUND

1. Field of the Invention

The present invention pertains to the fields of biomass processing and food chemistry. More specifically, the present invention relates to soybean hull fermentation methods that produce food additives containing significant quantities of high-quality protein.

2. Description of the Related Art

Soybeans are an important commercial crop that can be consumed directly by humans and animals, or used as a source of oil for such products as cooking oil, soap, cosmetics, resins, plastics, inks, solvents and biodiesel. As a food source, soybeans are unique among vegetables because they have a high protein content (38-45%) and a complete amino acid profile, i.e., they contain significant quantities of all of the essential amino acids that are necessary for humans and most animals. Complete amino acid profiles are usually found only in animal proteins derived from meat, milk and eggs. Soybeans also contain a significant amount of omega-3 fatty acids, which may inhibit blood clotting, reduce inflammation and promote healing, as well as isoflavones, which are phytoestrogens that have shown efficacy in the prevention of cancer and post-menopausal symptoms in some studies.

In the production of oil-based products, soybeans are subjected to a defatting process, where they are first separated from their hulls. The oil is then either solvent extracted or mechanically pressed from the soybeans. The remaining solids contain about 50% protein and are either sold directly as animal feed or blended with soybean hulls to increase fiber content for multigastric animals.

As an animal feed, soybean products compete with distillers dried grains (DDG) which are byproducts primarily of the corn ethanol industry. However, DDG suffer from the disadvantage that grains, in general, are deficient in the essential amino acids lysine and tryptophan. Further, proteins, peptides and free amino acids in the grains may be destroyed or chemically altered (e.g., racemized) during processing, and the presence of short peptide chains and free amino acids can lead to bitter off-flavors and reduced palatability. These chemical changes can also impair the nutritional quality and safety of foods by generating non-metabolizable and biologically non-utilizable forms of amino acids, which may compete with unaltered proteins for the active sites of proteases in the digestive system, thereby rendering the unaltered proteins less nutritionally available. M. Friedman “Chemistry, Nutritional and Microbiology of D-Amino Acids” J. Agric. Food Chem., 47 (9), 3457-3479, 1999.

The vast majority of ethanol produced from grain is designated as a gasoline additive, with current production at about 6 billion gallons per year in the United States. However, in order to make a significant impact toward replacing the current 140 billion gallons of gasoline used in the United States each year, additional sources of ethanol are needed. To meet this need without affecting the food sources of humans or animals, it is possible to utilize agricultural residues (biomass), such as corn stover and bagasse, which contain carbohydrates in the form of cellulose and hemicellulose that cannot be digested by most animals.

Production of ethanol from biomass generally requires three steps. The first step is a thermochemical pretreatment step involving the use of acidic or basic reagents that initiate depolymerization of complex plant biomass structure at elevated temperatures. These harsh pretreatment conditions tend to degrade proteins within the biomass, thereby reducing the nutritional value and palatability of the protein, as discussed above. The second step is enzymatic hydrolysis of the pretreated carbohydrates to produce simple sugars. Finally, fermentation of the sugars by microorganisms, such as yeast, produces ethanol.

### SUMMARY

The present invention advances the art and overcomes the problems outlined above by providing compositions having a significant quantity of high-quality protein, and soybean hull fermentation methods for producing these compositions. Ethanol from the fermentation process may be sold as fuel, and the protein compositions may be used as food additives.

In one embodiment, a food additive includes a concentrated soybean hull material, which contains less than 38 wt. % carbohydrates. The food additive may be produced by a process including: exposing untreated soybean hull material to a composition comprising carbohydrase enzymes that degrade a carbohydrate fraction of the untreated soybean hull material to produce a saccharification product; exposing the saccharification product to a sugar-to-ethanol converting microorganism to form a fermentation broth and produce ethanol; and isolating the concentrated soybean hull material from the fermentation broth.

In one embodiment, a food additive includes a composition comprising soybean hull material, wherein the soybean hull material has been concentrated by removal of a complex carbohydrate fiber fraction.

In one embodiment, a method of producing a food additive includes: exposing untreated soybean hull material to a composition comprising carbohydrase enzymes that degrade a carbohydrate fraction of the untreated soybean hull material to produce a saccharification product; exposing the saccharification product to a sugar-to-ethanol converting microorganism to form a fermentation broth and produce ethanol; isolating the soybean hull material from the fermentation broth to provide isolated soybean hull material that has less than 38 wt. % carbohydrates; and formulating an animal feed to include the isolated soybean hull material as a food additive in the animal feed.

### BRIEF DESCRIPTION OF THE DRAWINGS

FIG. 1 shows comparative data of ethanol yields for soybean hull simultaneous saccharification and fermentation experiments utilizing various pretreatment protocols.

FIG. 2 shows comparative data of ethanol yields for soybean hull simultaneous saccharification and fermentation experiments utilizing various pretreatment protocols.

FIG. 3 shows comparative data of soybean hull fermentations utilizing no pretreatment versus pretreatment with subsequent acid neutralization.

FIG. 4 shows comparative data of soybean hull fermentations utilizing various cellulase concentrations.

FIG. 5 shows comparative data of soybean hull fermentations utilizing various cellulase:β-glucosidase ratios.

FIG. 6 shows comparative data of soybean hull fermentations utilizing various combinations of cellulase, hemicellulase, pectinase and β-glucosidase.

FIG. 7 shows comparative data of soybean hull, corn stover and bagasse fermentations.

FIG. 8 shows residual glucose, protein and ethanol data for multiple soybean hull fermentations.

FIG. 9 shows residual glucose, protein and ethanol data for a soybean hull fermentation performed on a one liter scale.

FIG. 10 shows weight loss over time for fermentations performed using various ethanologens.

FIG. 11 shows ethanol yield over time for the fermentations of FIG. 10.

FIG. 12 shows high-performance liquid chromatography (HPLC) traces for the fermentations of FIGS. 10 and 11.

### DETAILED DESCRIPTION

There will now be shown and described high-protein food additives and methods for preparing the food additives by the fermentation of soybean hulls.

The term “food additive”, as used herein, refers to a nutritional product for consumption by a human or animal. A food additive may constitute between 0.1% to 100% of a consumable product, or between 5% and 95% of a consumable product, or between 10% and 80% of a consumable product. A food additive according to the present instrumentalities comprises a “concentrated soybean hull material” formed from soybean hulls that have had a major fraction of one or more components removed. The remaining components are then present in higher quantities relative to their concentration in the untreated soybean hull material. An exemplary concentrated soybean hull material, for example, may contain less than 38 wt. % carbohydrates (e.g., cellulose, hemicellulose, pectin), or less than 35 wt. %, 30 wt. %, 25 wt. %, 20 wt. %, 18 wt. %, 15 wt. %, 12 wt. % or 10 wt. % carbohydrates, whereas untreated soybean hulls generally contain about 9-12 wt. % crude protein, 14-25 wt. % cellulose, 14-20 wt. % hemicellulose, 10-12 wt. % pectin, 7-11 wt. % uronic acid, 4-5 wt. % ash and 3-4 wt. % lignin

It will be appreciated by those skilled in the art that soybean hull content may vary with soybean variety, growing region and conditions (e.g., soil content, sunlight exposure, fertilization, temperature, humidity, etc.), such that a determination of soybean hull content by analytical testing methods, which are known in the art, may be appropriate. In one embodiment, analytical testing may allow for the adaptation of the compositions and methods described herein to reduce or eliminate the observed variation, for example, to produce a food additive with consistent properties. In another embodiment, the content variation may be utilized to advantage to produce a food additive that meets the nutritional requirements of a particular animal. For example, soybean hull material with higher hemicellulose content may be processed according to the present methods to produce a food additive especially suitable for ruminants.

In one embodiment, a food additive may have “a complete amino acid profile”. The term “complete amino acid profile”, as used herein, shall refer to eight essential amino acids that cannot be synthesized in vivo, and which are present in sufficient quantities to provide proper nutrition. The eight essential amino acids are: phenylalanine, valine, tryptophan, threonine, isoleucine, methionine, lysine and leucine. The World Health Organization recommends the daily intakes shown in Table 1 for humans:

TABLE 1

| | Recommended daily intake in |
|---|---|
| | human adults |
| Name | (mg per Kg body weight) |
| Phenylalanine | 14 (sum with Tyrosine) |
| Valine | 10 |
| Tryptophan | 3 |
| Threonine | 7 |
| Isoleucine | 10 |
| Methionine | 13 (sum with Cysteine) |
| Lysine | 12 |
| Leucine | 14 |

Some animals, such as ruminants, have symbiotic bacteria in their digestive tracts. The bacteria are able to synthesize amino acids from non-protein nitrogen sources. However, the bacteria generally cannot synthesize enough protein to satisfy the nutritional requirements of the animal. Therefore, consumption of foods having a complete amino acid profile is important for all animals, but, in particular, for monogastric animals, such as pigs and chickens, that do not contain significant quantities of symbiotic bacteria.

Non-ruminant animals lack the ability to digest carbohydrate fiber material. Therefore, a food additive having a low complex carbohydrate fiber content and a high protein content, where the protein contains a complete amino acid profile, would be highly beneficial for non-ruminant animals. The concentrated soybean hull materials described herein may provide these benefits, and are therefore suitable for a wide variety of monogastric and multigastric animals including, but not limited to, bovine, ovine, avian, equine, porcine, caprine, leporine, feline, canine, humans and primates.

In one embodiment, a concentrated soybean hull material may contain at least 20 wt. % protein, or at least 25 wt. %, 28 wt. %, 30 wt. %, 35 wt. % or 40 wt. % protein.

Methods for producing concentrated soybean hull material include: exposing untreated soybean hull material to a composition comprising carbohydrase enzymes that degrade a carbohydrate fraction of the untreated soybean hull material to produce a saccharification product; exposing the saccharification product to a sugar-to-ethanol converting microorganism to form a fermentation broth and produce ethanol; and isolating the concentrated soybean hull material from the fermentation broth. The isolated soybean hull material is granular, or flowable, upon drying, which may be advantageous for large scale handling.

The disclosed methods do not require an acidic or basic pretreatment step because soybean hulls are unique in that the complex carbohydrates of soybean hulls are readily accessible to carbohydrase enzymes (cellulases, hemicellulases and the like). Soybean hulls require only enzymatic depolymerization of the complex carbohydrates prior to fermentation.

Elimination of an acidic or basic pretreatment step amounts to a significant cost savings, as pretreatment generally accounts for about 18% of the cost of producing ethanol from biomass. Acidic pretreatment also produces acid degradation products of some sugars, such as furfural from xylose and hydroxymethylfurfural from glucose. These degradation products decrease the available sugar for ethanol production. Additionally, acid degradation of biomass lignin produces low molecular weight phenolic byproducts that contribute to inhibition of fermentation. Finally, the benefits of eliminating the pretreatment are also augmented because most acidic or basic pretreatment processes attack the proteins found in biomass, thereby decreasing the nutritional value of the solid residue. Elimination of the pretreatment of soybean hulls permits the retention of high-quality protein with a complete amino acid profile. Additionally, other constituents such as isoflavones and omega-3 fatty acids are preserved throughout the saccharification and fermentation steps.

### EXAMPLES

### Organisms and Enzymes

Saccharomyces cerevisiae D₅A was obtained from the National Renewable Energy Laboratory (NREL). Zymomonas mobilis 8b (Zhang, M.; Eddy, C.; Deanda, K.; Finkelstein, M.; Picataggio, S. (1995) “Metabolic Engineering of a Pentose Metabolism Pathway in Ethanologenic Zymomonas mobilis,” Science 267:240-243) was obtained by material transfer agreement from NREL. E coli KO11 ATCC 55,124 (Asghari, A.; Bothast, R. J.; Doran, J. B.; Ingram, L. O. (1996) “Ethanol production from hemicellulose hydrolysates of agricultural residues using genetically engineered Escherichia coli strain KO11,” J. Industrial. Microbiol. 16: 42-47) was obtained from the American Type Culture Collection, Manassas, Va. Enzymes used were cellulase (Genencor, Beloit, Wis., Spezyme CP®) @59 filter paper units (FPU)/mL, β-glucosidase (Sigma-Aldrich Corp., St. Louis, Mo., Novozyme 188®, C6105) @380 U/ml, pectinase (Sigma-Aldrich Corp., St. Louis, Mo., P2736) @3093 U/mL, and hemicellulase (Sigma-Aldrich Corp., St. Louis, Mo., H2125) @150 KU/g. Except for FPU (Zhang, Y.-H.; Himmel, M. E.; Mielenz, J. R. (2006) “Outlook for Cellulase Improvement: Screening and Selection Strategies,” Biotechnol. Adv. 24, 452-481), the enzyme units are defined by the manufacturer.

### Small Scale Fermentations

In the following examples, pelletized soybean hulls (sbh) obtained from Ag Processing Inc., Hastings, Nebr. were used. The sbh were experimentally determined to contain 35% glucan (which can include pectin monomers), 9.3% xylan, 10.3% protein and 9.1% moisture. The pellets were ground in a Wiley mill prior to fermentation. Fermentations containing approximately 8% to 17% soybean hulls by weight were conducted in sealed 70 ml reusable BBL Septi-Chek bottles using 3 g sbh per bottle unless otherwise noted. The medium for the S. cerevisiae fermentation contained sbh, enzymes and yeast cells and, where noted, NH₄SO₄ was added to 0.25 gram per vial with water to reach the biomass loading target. E. coli KO11 fermentations contained a final concentration of 100 mM NaCl, 1 mM MgCl₂.H₂O and 1 mM CaCl₂.2H₂O with no added nitrogen. Z. mobilis 8b fermentations contained 1 mM MgCl₂.H₂O, 1 mM CaCl₂.2H₂O and 10 mM NaHPO₄ at pH 7 with no added nitrogen. All enzymes were added on a per gram sbh weight. S. cerevisiae D₅A was grown in YEPD medium (Difco, Detroit, Mich.), and E. coli KO11 and Z. mobilis 8b were grown in Luria broth, to stationary phase to provide fermentation inoculum. For typical fermentations, all components except enzymes and cells were added to the vials and autoclaved for 20 minutes and cooled. Bottles were weighed to the nearest 10 mg as tare and as components were added, after autoclaving and throughout the fermentations. The cells and enzymes were added, and the vials were sealed. Fermentations were conducted with shaking at 36° C. using a New Brunswick C24 shaker (New Brunswick Instrument Company, New Brunswick, N.J.) at 100 rpm. Bottles were vented with a sterile needle during fermentation to release CO₂ prior to weighing

### Controlled Fermentations

Fermentations were also conducted in Applikon 3 L jacket fermentors at 36° C. with an agitation speed of 150 rpm with sbh at about a 10% loading (w/w) and 10 mM NaHPO₄ at pH 7. After autoclaving and cooling, the fermentor was degassed with nitrogen prior to addition of cells and enzymes. Cellulase and β-glucosidase were added at 5.0 U/g sbh each. Samples were frozen at −70° C. prior to analysis.

### Analysis

Fermentation performance was determined by HPLC after centrifugation of samples at top speed for two minutes and filtering of the supernatant through a 0.45 micron filter to remove solids using the method of Yang, B.; Wyman, C. E. (2004) “Effect of xylan and lignin removal by batch and flow through pretreatment on the enzymatic digestibility of corn stover cellulose,” Biotechnol. Bioeng. 86: 88-98. Residual sugars in the solid residues were assayed per the NREL quantitative saccharification method described by Ehrman, C. (1994) “Method for determination of total solids in biomass.” In: Laboratory Analytical Procedure No. 001. National Renewable Energy Laboratory, Golden, Colo., and the resulting sugars were analyzed by HPLC. Protein analysis from bottle fermentations were conducted with a ThermoFinnigan FlashEA 1112 N/Protein Analyzer (CE Elantech, Lakewood, N.J.). Controlled fermentor samples were analyzed for protein content by Rock River Laboratory, Watertown, Wis. using a Carlo Erba nitrogen analyzer, and in all cases protein levels were calculated as 6.25 times the sample nitrogen content (Delorme, C. B.; Wojcik, J.; Gordon, C. (1981) “Method of addition of cellulose to experimental diets and its effect on rat growth and protein utilization,” J. Nutrition. 111: 1522-7).

### Example 1

### Comparative Testing of Pretreatment Conditions for Soybean Hull Material

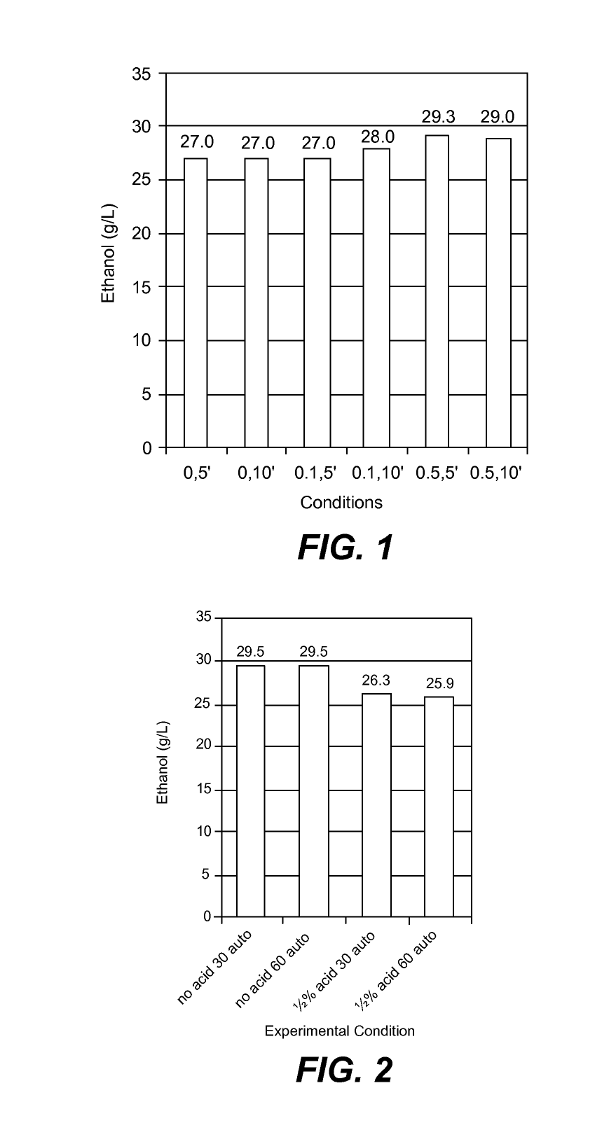

Soybean hulls were tested to determine the benefit of a pretreatment protocol utilizing low levels of sulfuric acid and moderate temperatures provided by a steam autoclave. The soybean hull loading was 16.66% (w/v for all cases), and acid treatments of 0%, 0.1% and 0.5% H₂SO₄ with autoclaving at 121° C. for zero, five or ten minutes were used to partially hydrolyze the carbohydrates in the soybean hulls. Cellulase and β-glucosidase were added at 14.8 and 15.2 U/g sbh, respectively, to effect enzymatic saccharification. Fermentation was effected by S. cerevisiae at 35° C. and 100 rpm agitation, with 100 Ug/mL streptomycin to eliminate bacterial contamination. Fermentation proceeded for six days and the concentration of ethanol was determined by HPLC. As shown in FIG. 1, pretreatment with 0.5% H₂SO₄ provided a small increase in ethanol yield at 29.2 and 28.9 g/L for five and ten minute autoclaving, compared to 27 and 28 g/L at 0.1% H₂SO₄ with five and ten minute autoclaving. No acid pretreatment yielded 27 g/L with five and ten minute autoclaving. Therefore, acid pretreatment yielded at most 7.8% more ethanol than when no pretreatment protocol was utilized. It should be noted that pH values for the various samples ranged from 7.1 (no acid, five minute autoclave) to 4.1 (0.1% acid, five minute autoclave).

### Example 2

### Comparative Testing of Acid Pretreatment and Autoclave Conditions for Soybean Hull Material

Experiments were conducted using a 15% sbh loading where the soybean hulls were pretreated using 0%, 0.5% and 1% H₂SO₄ autoclaved for thirty or sixty minutes. In a second step, enzymatic saccharification proceeded with an enzyme loading of 14.8±0.2 U/g sbh of cellulase, 31.3±0.3 U/g sbh of β-glucosidase, 100 Ug/mL streptomycin and approximately 50 mM ammonium sulfate. Fermentation was effected by S. cerevisiae at 35° C. and 100 rpm agitation. Fermentation proceeded for nine days. pH values ranged from 4.4 to 2.7. As shown in FIG. 2, untreated samples (i.e., 0% H₂SO₄) yielded high levels of ethanol at 29.5 g/L regardless of autoclave time, while the 0.5% acid samples yielded 26.3 and 25.9 g/L for thirty and sixty minute autoclave times, respectively. The 1% acid treatment yielded no fermentation, presumably due to the very low pH of 2.7-2.8. These experiments confirmed the competitive, and sometimes superior, results of fermenting soybean hulls without acid pretreatment.

### Example 3

### Neutralization of Pretreated Soybean Hull Material

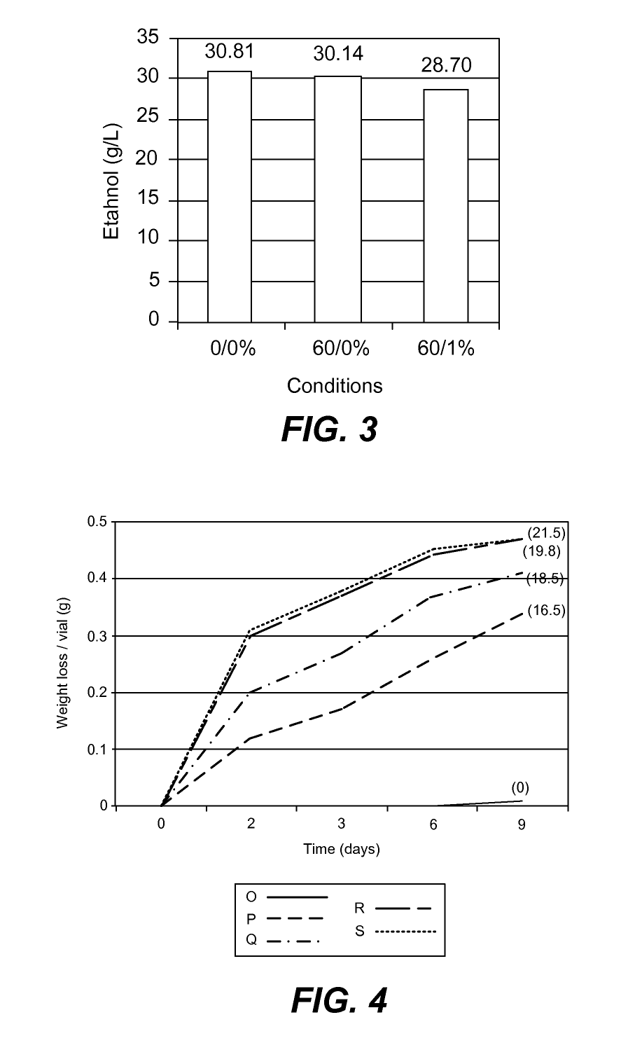

Experiments testing the following three pretreatment conditions were implemented: no autoclaving, no acid; sixty minute autoclave (121° C.), no acid; sixty minute autoclave (121° C.), 1% H₂SO₄. All samples were neutralized after acid treatment and then autoclaved fifteen minutes for sterility. These conditions were tested with a 15.4%, 15.3% and 14.7% sbh loading, respectively, and were followed by enzymatic saccharification utilizing 14.8±0.3 U/g cellulase and 31.1±0.6 U/g β-glucosidase. The pH was adjusted to at least 5 prior to fermentation by S. cerevisiae at 35° C. and 100 rpm agitation. After nine days of fermentation, high levels of ethanol were obtained for all conditions: no autoclaving, no acid yielded 30.8 g/L ethanol; sixty minute autoclave, no acid yielded 30.1 g/L ethanol; and sixty minute autoclaving, 1% acid yielded 28.7 g/L ethanol, as shown in FIG. 3. Clearly, adjustment of the pH to at least 5 provided for effective fermentation as the residual glucose for these conditions was 1.8%, 1.1% and 2.1% compared to the starting glucose level of 35%.

### Example 4

### Effects of Enzyme Loading on Fermentation of Soybean Hull Material

Experiments comparing the effect of no added enzymes (i.e., no enzymatic saccharification) to fixed levels of β-glucosidase (10.0±0.1 U/g sbh) with cellulase loadings of 0, 0.8, 1.7, 3.3 and 5.0 U cellulase/g sbh were conducted. The trials are labeled O-S in Table 2 and FIG. 4, which show that increasing cellulase concentration increased ethanol yield. Enzymatic saccharification with cellulase loadings of 0, 0.8, 1.7, 3.3 and 5.0 U cellulase/g sbh yielded 0, 16.5, 18.5, 19.8 and 21.5 g/L ethanol after nine days of fermentation with S. cerevisiae at 35° C. and 100 rpm agitation. The progress of fermentation was monitored by weighing the sealed sample bottles and determining the amount of CO₂ that had been lost as a byproduct of fermentation after venting briefly with a needle. Weight loss was due to escape of CO₂ and minor amounts of water vapor, which were not quantified. The results are shown in FIG. 4, where it can be observed that fermentation proceeded faster with higher levels of cellulase. Residual glucose was consistent with the increased hydrolysis trend where 0, 0.8, 1.7, 3.3 and 5.0 U cellulase/g sbh resulted in residual glucose levels of 36%, 12%, 6.8%, 6.8% and 5.5%.

TABLE 2

| | Cellulase | β-glucosidase | | Ethanol, | Residual |
|---|---|---|---|---|---|
| Trial | (U/g) | (U/g) | CO₂ (g) | g/L | Glucose, % |
| O | 0 | 0 | 0.01 | 0 | 36 |
| P | 0.8 | 9.9 | 0.34 | 16.5 | 12 |
| Q | 1.7 | 9.9 | 0.41 | 18.5 | 6.8 |
| R | 3.3 | 10.0 | 0.47 | 19.8 | 6.8 |
| S | 5.0 | 9.9 | 0.47 | 21.5 | 5.5 |
| T | 5.0 | 9.9 | 0.5 | 25.9 | 5.0 |
| (no added | | | | | |
| nitrogen) | | | | | |
| U | 1.7 | 4.9 | 0.41 | 18.5 | 6.8 |
| V | 4.9 | 4.9 | 0.47 | 22.4 | 5.4 |

### Example 5

### Effect of the Ratio of Cellulase to Beta-Glucosidase on Fermentation of Soybean Hull Material

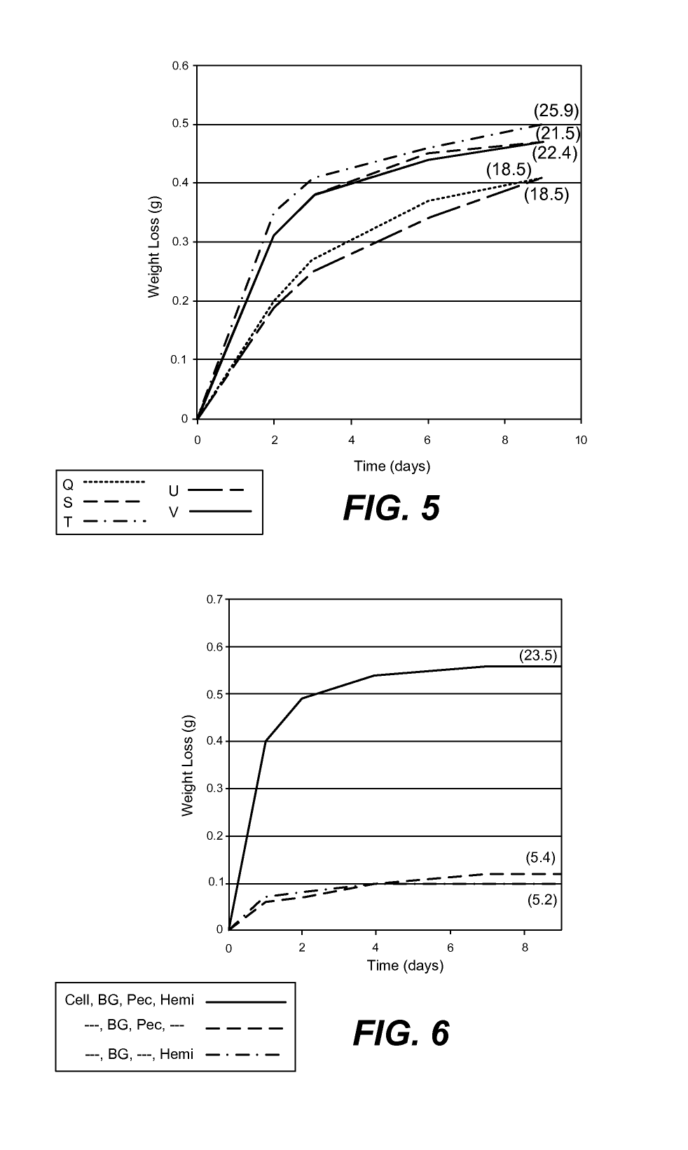

Experiments were conducted to determine the effect of the ratio of cellulase to β-glucosidase during enzymatic saccharification, and the impact of removing the added ammonium sulfate. FIG. 5 shows the results with cellulase:β-glucosidase ratios of approximately 1.7:10, 1.7:5, 5:5, 5:10 and 5:10 with no (NH₄)₂SO₄. Carbon dioxide loss was followed to determine the rate of conversion. Final ethanol yields were 18.5, 18.5, 22.4, 21.5 and 25.9 g/L, respectively. These results were determined as a function of ethanol yield after fermentation with S. cerevisiae at 35° C. and 100 rpm agitation. Reducing β-glucosidase to 5 U/g sbh did not significantly reduce the rate of CO₂ loss or ethanol yield when the cellulase was dosed at 5 U/g sbh (S versus V, Table 2, FIG. 5). However, 1.7 U cellulase/g sbh was insufficient to rapidly hydrolyze the cellulose compared to 5 U cellulase/g sbh regardless of whether the β-glucosidase was present at 5 or 10 U/g sbh (U versus Q, Table 2, FIG. 5). Elimination of the ammonium sulfate provided the most rapid CO₂ release and the highest yield of ethanol at 25.9 g/L ethanol. Thus, there is no need to add additional nitrogen during fermentation.

### Example 6

### Effect of Added Pectinase and Hemicellulase on Fermentation of Soybean Hull Material

In addition to cellulase and β-glucosidase, two additional enzymes were tested for contributions to enzymatic saccharification of soybean hull material. Trials with low levels of pectinase and hemicellulase were compared to trials with cellulase and β-glucosidase. In a trial with 10% sbh loading and cellulase:β-glucosidase 4.9:15.3 U cellulase/g sbh, fermentation of the saccharification product by S. cerevisiae at 35° C. and 100 rpm agitation yielded 17.4 g/L ethanol. As shown in Table 3, the addition of pectinase to sample X (Table 3) and hemicellulase to sample BB (Table 3) increased CO₂ loss. Specifically, addition of pectinase at 161 U/g sbh or hemicellulase at 4.4 U/g sbh produced a final ethanol yield of 19.7 or 17.5 g/L compared to no added pectinase or hemicellulase, which yielded approximately 17.4 g/L ethanol. Residual glucose yields of 1.2% w/w and 3.8% w/w were observed compared to 4.4% w/w with no added pectinase or hemicellulase. The reduced glucose content was consistent with the release of pectin monomers that were fermented to ethanol, while hemicellulase did not materially reduce the glucose level nor increase ethanol. Hemicellulase hydrolyzes hemicellulose to xylose oligomers and monomers which cannot be fermented to ethanol by S. cerevisiae D₅A, while pectinase degradation products should be fermented to ethanol by S. cerevisiae.

TABLE 3

| | Ethanol (g/L) | CO₂ (g) | Residual Glucose |
|---|---|---|---|
| No added | 17.4 | 0.44 | 4.4% |
| hemicellulase or | | | |
| pectinase (W) | | | |
| Hemicellulase (BB) | 17.5 | 0.46 | 3.8% |
| Pectinase (X) | 19.7 | 0.55 | 1.2% |

### Example 7

### Effect of Enzymes on Fermentation of Soybean Hull Material

Fermentations using a 9.9% to 10.3% sbh loading were conducted over the course of nine days with S. cerevisiae at 35° C. and 100 rpm agitation. Cellulase was added at 4.9 U/g sbh; β-glucosidase was added at 15.2 U/g sbh; pectinase was added at 167 U/g sbh; and hemicellulase was added at 4.5 U/g sbh. As shown in FIG. 6, enzymatic saccharification with cellulase, pectinase, hemicellulase and β-glucosidase during fermentation, as described above, yielded 23.5 g/L ethanol. Removal of cellulase from the enzymatic saccharification step dramatically reduced the ethanol yield; enzymatic saccharification with a combination of pectinase and β-glucosidase yielded 5.4 g/L ethanol, and enzymatic saccharification with a combination of hemicellulase and β-glucosidase yielded 5.2 g/L ethanol.

### Example 8

### Comparison of Soybean Hulls to Corn Stover and Bagasse

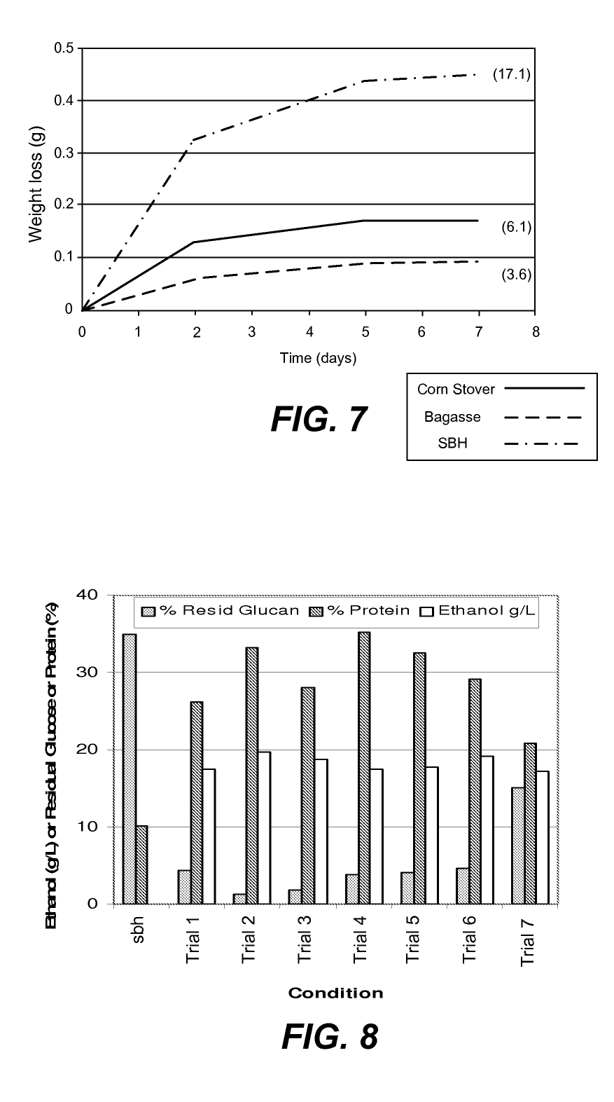

A comparison of soybean hull fermentation to corn stover and bagasse was conducted without acid pretreatment. Enzymatic saccharification with cellulase (4.9±0.1 U/g sbh) and β-glucosidase (15.2±0.2 U/g sbh) was performed on all of the samples. As shown in FIG. 7, the same enzymatic saccharification and fermentation conditions that yielded 17.1 g/L ethanol with soybean hulls yielded 3.6 g/L ethanol with bagasse and 6.1 g/L ethanol with corn stover.

### Example 9

### Increased Nitrogen Content of Soybean Hull Material

Soybean hulls contain 10-12% protein. Enzymatic saccharification and fermentation of the carbohydrate portion of the soybean hulls to ethanol leads to an increase in protein content, the level of which is dependent upon treatment conditions. As shown in FIG. 8, six samples (Trials 1-6) of sbh were fermented with S. cerevisiae D₅A under varying enzyme conditions (Table 4) with sufficient time to reach stable fermentation yields. Soybean hull loading was between 9.9% and 10.2%. As shown in Table 4, these fermentations yielded between 17.4 and 20 g/L ethanol and the residues contained protein concentrations of 26% to 36% by weight, compared to untreated soybean hulls at 10.2% protein. Residual glucose after fermentation was below 5% compared to untreated soybean hulls, which contain approximately 35% glucose.

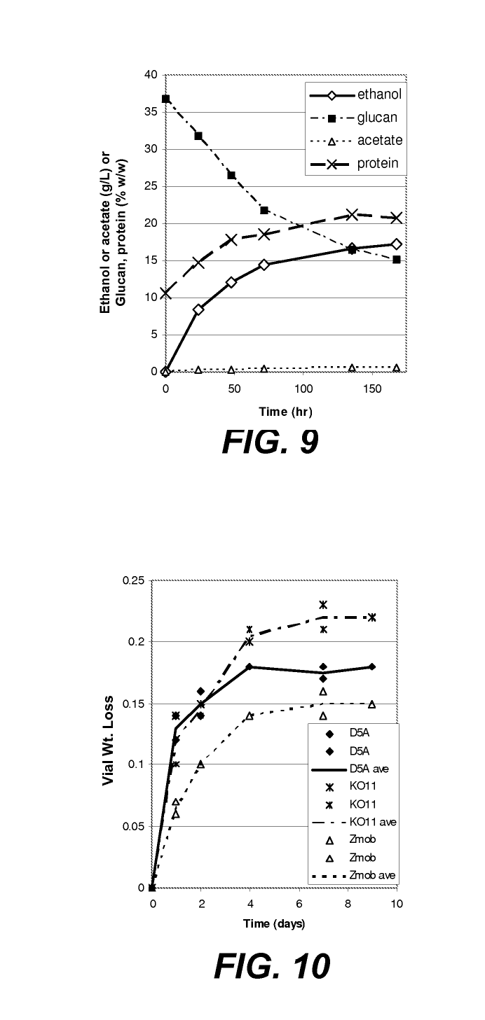

Additionally, a 1 L fermentation was conducted (Trial 7) with 9.6% (g/g) sbh loading with 5.0 FPU cellulase/g sbh and 5.0 β-glucosidase/g sbh. The fermentation was carried out for seven days until ethanol production leveled out. FIG. 9 shows the fermentation profile where the final ethanol concentration was 17.5 g/L, the residual glucose concentration was 15% and the protein content was 21%. Since the sbh loading was relatively low and no pectinase was added, this ethanol yield is lower than those obtained in other experiments. However, a good correlation between loss of glucose and increase in ethanol and protein concentrations with time was observed.

TABLE 4

| | | β- | | Hemi- | % | | |
|---|---|---|---|---|---|---|---|
| | | glucosidase | Pectinase | cellulase | Residual | % | Ethanol |
| Sample | CellulaseFPU/g | U/g | U/g | U/g | Glucan | Protein | g/L |
| sbh | 0 | 0 | 0 | 0 | 35 | 10.2 | 0 |
| Trial 1 | 4.9 | 15.1 | 0 | 0 | 4.39 | 26.2 | 17.40 |
| Trial 2 | 4.9 | 14.7 | 161 | 0 | 1.23 | 33.2 | 19.70 |
| Trial 3 | 4.9 | 15.3 | 1670 | 0 | 1.9 | 28.0 | 18.70 |
| Trial 4 | 4.9 | 14.9 | 0 | 4.4 | 3.84 | 35.3 | 17.50 |
| Trial 5 | 4.9 | 15.1 | 0 | 17.9 | 4.03 | 32.5 | 17.80 |
| Trial 6 | 4.9 | 15.3 | 0 | 45.2 | 4.59 | 29.2 | 19.10 |
| Trial 7 | 5.0 | 5.0 | 0 | 0 | 15.1 | 20.9 | 17.5 |

### Example 10

### Effect of Microorganism Selection Upon Soybean Hull Fermentation

Based upon successful fermentation of sbh to ethanol by S. cerevisiae, additional ethanologens, E. coli KO11 and Z. mobilis 8b, were tested. Cellulase at 4.9 FPU/g and β-glucosidase at 15.3-15.4 U/g sbh were added to all vials. Pectinase was included only in vials containing S. cerevisiae, while hemicellulase was included for select tests (Table 5). The highest ethanol yields resulted from use of E. coli with added hemicellulase and S. cerevisiae with added pectinase. Hemicellulase provided minimal improvement with Z. mobilis. Pectinase products were found to inhibit the bacterial strains in the absence of further purification. These results showed that several ethanologens were capable of achieving high levels of ethanol from sbh without pretreatment.

TABLE 5

| | Cellulase FPU/g | | | | | |
|---|---|---|---|---|---|---|
| | B-glucosidase U/g | Pectinase U/g | Hemicellulase U/g | Wt. loss g | Residual Glucose | Ethanol g/L |
| S. cerevisiae D₅A | 4.9/15.3 | 167 | 0 | 0.56 | ND | 23.5 |
| E coli KO11 | 4.9/15.3 | 0 | 4.5 | 0.68 | ND | 28.8 |
| Z mobilis 8b | 4.9/15.4 | 0 | 4.5 | 0.45 | ND | 18.2 |
| Z mobilis 8b | 4.9/15.4 | 0 | 0 | 0.4 | ND | 17.3 |

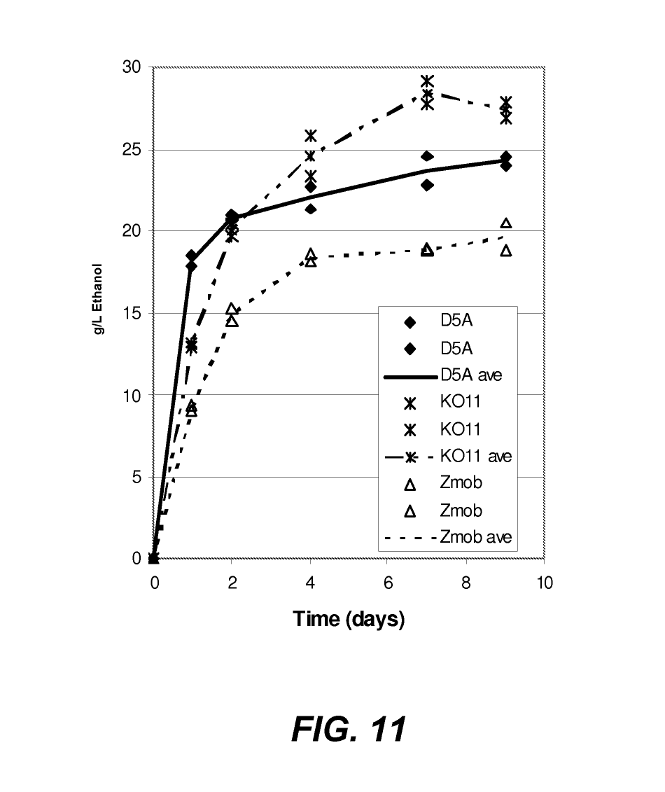

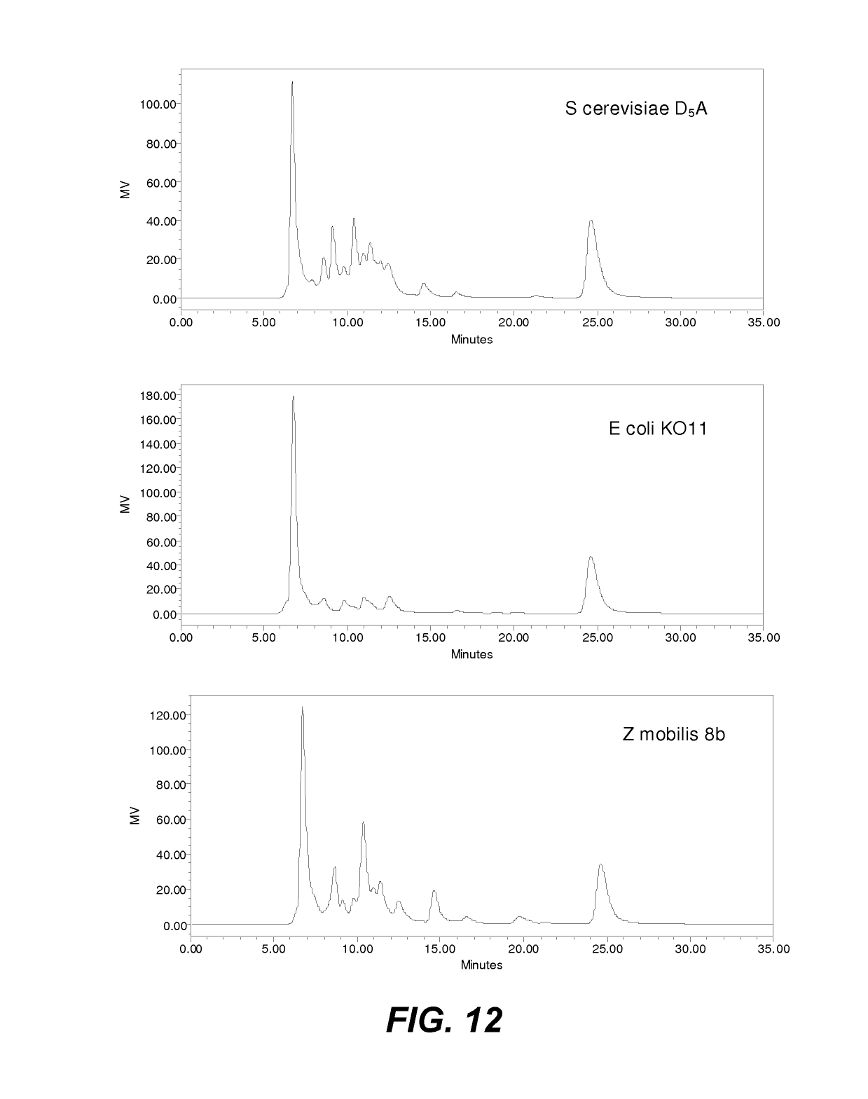

To test the differences among these ethanologens and eliminate the possibility that sampling influenced the fermentation, thirty-six nearly identical vials were prepared containing approximately one gram sbh at about 8.4% (g/g) loading with differences only in added salts, enzymes and the inoculum. Twelve vials were each charged with S. cerevisiae D₅A, E. coli KO11 or Z. mobilis 8b, plus enzymes loaded at 4.8 FPU/g sbh cellulase, 14.8±0.1 U/g sbh β-glucosidase and 13.2±0.1 U/g sbh hemicellulase for all vials, and 485 U/g sbh pectinase for S. cerevisiae. Two vials were removed randomly from each set of twelve at various times, vented, weighed and frozen at −80° C. For analysis, the samples were thawed and assayed for ethanol production. FIG. 10 shows the results of the weight loss versus time for each ethanologen, while FIG. 11 shows ethanol yield from all three microorganisms. The line plots represent the average of the two samples, and both figures demonstrate that vial weight loss is an effective indicator for tracking ethanol yield. Analysis of the samples by HPLC (FIG. 12) showed a significant reduction in residual soluble materials detectable with a RI detector for E. coli KO11 compared to the other ethanologens. An initial peak at 7 minutes is attributable to acid in the buffer, with ethanol appearing at about 24.5 minutes. Residual carbohydrates appear at 8.5-15 minutes. E. coli KO11 most likely produced the highest level of ethanol because it is able to utilize xylose, pectin and uronic acid (Doran, J. B.; Cripe J.; Sutton, M.; Foster, B. “Fermentation of pectin-rich biomass with recombinant bacteria to produce fuel ethanol”, Appl. Microbiol. Biotechnol. 84-86: 141-152, 2000). Ethanol yields increased in the order Z. mobilis 8b<S. cerevisiae D₅A<E. coli KO11.

Although the above Examples describe fermentations using Saccharomyces cerevisiae, Zymomonas mobilis or Escherichia coli as the sugar-to-ethanol converting microorganism, those skilled in the art will appreciate that other microorganisms, such as Klebsiella oxytoca, may be used for similar effect.

All references mentioned in this application are incorporated by reference to the same extent as though fully replicated herein.

What is claimed is:

1. A food additive comprising a modified soybean hull material, said modified soybean hull material being produced from an untreated soybean hull material by a process comprising:
(a) exposing said untreated soybean hull material to a composition comprising a carbohydrase enzyme, wherein said untreated soybean hull material comprises a carbohydrate fraction, said carbohydrase enzyme degrading said carbohydrate fraction to produce a saccharification product;
(b) exposing the saccharification product to a sugar-to-ethanol converting microorganism to form a fermentation broth and produce ethanol; and
(c) isolating solid residues from the fermentation broth to provide said modified soybean hull material,
wherein said process does not include an acidic or basic pretreatment step to pretreat said untreated soybean hull material before step (a).

2. The food additive of claim 1, wherein said modified soybean hull material comprises less than 5% (w/w) glucose.

3. The food additive of claim 1, wherein the modified soybean hull material further comprises at least 20% (w/w) protein.

4. The food additive of claim 1, wherein the modified soybean hull material further comprises at least 30% (w/w) protein.

5. The food additive of claim 1, wherein said modified soybean hull material comprises less than 10% (w/w) cellulose.

6. The food additive of claim 3, wherein the protein consists essentially of non-racemized protein.

7. The food additive of claim 3, wherein the protein consists essentially of unhydrolyzed protein.

8. The food additive of claim 1, wherein the modified soybean hull material further comprises isoflavones.

9. The food additive of claim 1, wherein the carbohydrase is at least one member selected from the group consisting of cellulase and beta-glucosidase.

10. The food additive of claim 1, wherein the sugar-to-ethanol converting microorganism is S. cerevisiae.

11. A method of producing a food additive and ethanol, said method comprising:
(a) exposing an untreated soybean hull material to a composition comprising a carbohydrase enzyme, said enzyme degrading a carbohydrate fraction of the untreated soybean hull material to produce a saccharification product;
(b) exposing the saccharification product to a sugar-to-ethanol converting microorganism to form a fermentation broth and to produce ethanol; and
(c) isolating solid residues from the fermentation broth to provide a food additive, said food additive having less than 35% (w/w) carbohydrates,
wherein said method does not include an acidic or basic pretreatment step to pretreat said untreated soybean hull material before step (a).

12. The method of claim 11, further comprising a step of adding said food additive into an animal feed.

13. The method of claim 11, wherein the modified soybean hull material further comprises at least 20% (w/w) protein.

14. The method of claim 13, wherein the protein consists essentially of non-racemized protein.

15. The method of claim 13, wherein the protein consists essentially of unhydrolyzed protein.

16. The method of claim 11, wherein the carbohydrase is at least one member selected from the group consisting of cellulase and beta-glucosidase.

17. The method of claim 11, wherein the carbohydrase comprises cellulase and beta-glucosidase.

18. The method of claim 11, wherein the sugar-to-ethanol converting microorganism is S. cerevisiae.

19. A food additive comprising a modified soybean hull material, wherein said modified soybean hull material contains less than 5% (w/w) glucose and at least 20% (w/w) protein, wherein said protein consists essentially of unhydrolyzed protein.
